(19) United States
(12) Patent Application Publication
(10) Pub. No.: US 2014/0035728 A1
(43) Pub. Date: Feb. 6, 2014

(54) RFID READER, RFID TAG AND RFID SYSTEM

(71) Applicant: Samsung Electronics Co., Ltd., Suwon-Si (KR)

(72) Inventors: Sanghyo LEE, Seoul (KR); Iljong SONG, Yongin-si (KR)

(73) Assignee: SAMSUNG ELECTRONICS CO., LTD., Suwon-Si (KR)

(21) Appl. No.: 13/955,088

(22) Filed: Jul. 31, 2013

(30) Foreign Application Priority Data
Aug. 2, 2012 (KR) 10-2012-0084942

(51) Int. Cl. G06K 7/10

(52) U.S. Cl. CPC G06K 7/10198
USPC 340/10.1

(57) ABSTRACT

An RFID reader for communication with an RFID tag includes an RF unit configured to communicate with the RFID tag according to an operating period of the RFID reader. The operating period includes a first period in which the RF unit communicates with the RFID tag, and the operating period includes a second period in which the RF unit does not communicate with the RFID tag. The RFID reader includes a microcontroller unit configured to control a quality factor of the RF unit according to a change in the operating period. The RFID reader includes a power supply configured to supply power to the RF unit and the microcontroller unit.

### CROSS-REFERENCE TO RELATED APPLICATIONS

A claim for priority under 35 U.S.C. §119 is made to Korean Patent Application No. 10-2012-084942 filed Aug. 2, 2012, in the Korean Intellectual Property Office, the entire contents of which are hereby incorporated by reference.

### BACKGROUND

Inventive concepts of at least one example embodiment relate to a Radio Frequency Identification (hereinafter, referred to as RFID) reader, an RFID tag, and/or an RFID system, and more particularly, to a technique capable of controlling a quality factor (Q).

An RFID system may be formed of an electronic tag (also referred to as a transponder) and an RFID reader (also referred to as an interrogator) Inherent identification may be assigned to the tag, and the RFID reader may read information from the tag using a radio frequency. RFID systems may be classified as an inductively coupled system or an electromagnetic wave system according to a communication method between the tag and the RFID reader. RFID systems may be also be classified as an active type or a passive type based on whether the tag is self-powered.

RFID systems may use a high frequency of a 13.56 MHz band based on the ISO 14442 standard. Accordingly, RFID readers and the RFID tags may perform data communication according to the ISO 14442 standard. Meanwhile, in the revised plan of the ISO 14442 standard, standardization on Very High Bit Rate (VHBR) communications supporting a data rate of 13.56 Mbps may be proposed. Due to a relatively high data rate, VHBR communications may use a wide bandwidth. In this case, the RFID reader and/or the RFID tag should have a relatively low quality factor. However, in the case of a passive tag powered by a carrier frequency, if a quality factor (Q) of the reader and/or the tag is too low, power is not sufficiently supplied. Also, power consumption of the reader may increase in order to sufficiently supply power to the tag. This may cause problems at a mobile reader employing near filed communication (NFC).

### SUMMARY

According to at least one example embodiment, an RFID reader for communication with an RFID tag, the RFID reader includes an RF unit configured to communicate with the RFID tag according to an operating period of the RFID reader. The operating period includes a first period in which the RF unit communicates with the RFID tag. The operating period also includes a second period in which the RF unit does not communicate with the RFID tag. The RFID reader includes a microcontroller unit configured to control a quality factor of the RF unit according to a change in the operating period. The RFID reader also includes a power supply configured to supply power to the RF unit and the microcontroller unit.

According to at least one example embodiment, the RF unit has a different quality factor associated with each of the first and second periods.

According to at least one example embodiment, a first quality factor in the first period a second quality factor is higher than the first quality factor in the second period.

According to at least one example embodiment, the quality factor is constant in the first period.

According to at least one example embodiment, the second period includes a period during which the quality factor varies over time.

According to at least one example embodiment, the quality factor increases over time during a first duration of the period.

According to at least one example embodiment, the quality factor decreases over time during a second duration of the period.

According to at least one example embodiment, the microcontroller unit is configured to control the RF unit such that the quality factor of the RF unit increases if the operating period changes into the second period from the first period, and control the RF unit such that the quality factor of the RF unit decreases if the operating period changes into the first period from the second period.

According to at least one example embodiment, the RF unit includes a variable resistor, and the microcontroller unit is configured to control a resistance value of the variable resistor to determine an impedance of the RF unit.

According to at least one example embodiment, the variable resistor is connected in series with an inductor and a capacitor.

According to at least one example embodiment, the microcontroller unit is configured to decrease a resistance value of the variable resistor if the operating period changes into the second period from the first period, and increase a resistance value of the variable resistor if the operating period changes into the first period from the second period.

According to at least one example embodiment, an RFID tag which communicates with an RFID reader includes an RF unit configured to communicate with the RFID reader according to an operating period of the RFID tag. The operating period includes a first period during which the RF unit communicates with the RFID reader. The operating period includes a second period during the RF unit does not communicate with the RFID reader. The RFID tag includes a microcontroller unit configured to control a quality factor of the RF unit according to a change in the operating period.

According to at least one example embodiment, the RF unit has a first quality factor in the first period and a second quality factor higher than the first quality factor in the second period.

According to at least one example embodiment, the microcontroller unit is configured to control the RF unit such that the quality factor of the RF unit increases if the operating period is changed into the second period from the first period, and control the RF unit such that the quality factor of the RF unit decreases if the operating period is changed into the first period from the second period.

According to at least one example embodiment, the RF unit includes a variable resistor connected in parallel with an inductor and a capacitor, and the microcontroller unit is configured to control a resistance value of the variable resistor to determine an impedance of the RF unit.

According to at least one example embodiment, the first RF unit includes a first variable resistor is connected in series with a first inductor and a first capacitor, and the second RF unit includes a second variable resistor connected in parallel with a second inductor and a second capacitor.

According to at least one example embodiment, an RFID system includes an RFID reader and an RFID tag. Each of the RFID reader and the RFID tag are configured to operate in a first period where the RFID reader and the RFID tag communicate with each other and a second period where the RFID reader and the RFID tag do not communicate with each other. Quality factors of the RFID reader and the RFID tag in the second period are higher than quality factors of the RFID reader and the RFID tag in the first period.

According to at least one example embodiment, the RFID reader includes a first RF unit configured to perform data communication with the RFID tag to correspond to an operating period of the RFID reader and a first microcontroller unit configured to control a quality factor of the first RF unit according to a variation in the operating period and a power supply configured to supply a power to the first RF unit and the first microcontroller unit.

According to at least one example embodiment, the RFID tag includes a second RF unit configured to perform data communication with the RFID reader to correspond to an operating period of the RFID tag and a second microcontroller unit configured to control a quality factor of the second RF unit according to a variation in the operating period.

According to at least one example embodiment, the quality factors of the RFID reader and the RFID tag are controlled at the same time.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating an RFID reader according to at least one example embodiment of the inventive concepts.

FIG. 2A is a diagram illustrating an operating period of an RFID reader and a variation in a quality factor according to a variation in the operating period, according to at least one example embodiment.

FIG. 2B is a diagram illustrating an operating period and a quality factor of a conventional RFID tag communicating with the RFID reader of FIG. 1.

FIG. 3 is a block diagram schematically illustrating an equivalent circuit of an RF unit of an RFID reader of FIG. 1.

FIG. 4 is a block diagram schematically illustrating an RFID tag according to at least one example embodiment of the inventive concepts.

FIG. 5A is a diagram illustrating an operating period of an RFID tag and a variation in a quality factor according to a variation in the operating period, according to at least one example embodiment.

FIG. 5B is a diagram illustrating an operating period and a quality factor of a conventional RFID reader communicating with the RFID tag of FIG. 4.

FIG. 6 is a block diagram schematically illustrating an equivalent circuit of an RF unit of an RFID tag of FIG. 4.

FIG. 7 is a block diagram schematically illustrating an RFID system according to at least one example embodiment of the inventive concepts.

### DETAILED DESCRIPTION OF EXAMPLE EMBODIMENTS

Embodiments will be described in detail with reference to the accompanying drawings. The inventive concepts, however, may be embodied in various different forms, and should not be construed as being limited only to the illustrated embodiments. Rather, these embodiments are provided as examples so that this disclosure will be thorough and complete, and will fully convey the concept of the inventive concepts to those skilled in the art. Accordingly, known processes, elements, and techniques are not described with respect to some of the embodiments of the inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

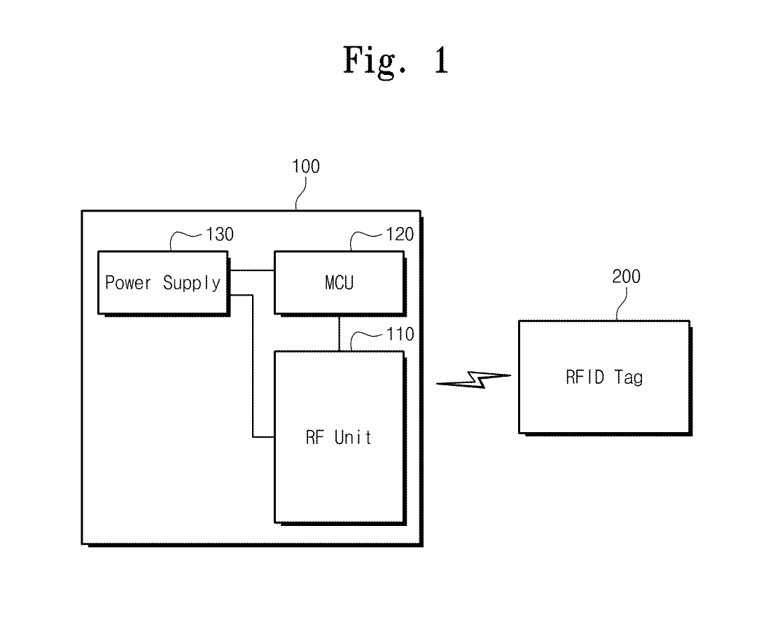

FIG. 1 is a block diagram schematically illustrating an RFID reader according to at least one example embodiment of the inventive concepts.

Referring to FIG. 1, an RFID reader 100 according to an embodiment of the inventive concept may include an RF unit 110, a microcontroller unit 120, and a power supply 130. In the following description, it is assumed that an RFID tag 200 is a passive tag. That is, the RFID tag 200 may be supplied with power from the RFID reader 100.

When the RFID tag approaches a coverage area of the RFID reader 100, the RF unit 110 may be electrically connected with the RFID tag 200. The coverage may indicate a zone where the RFID tag 200 reacts to an RF signal output from the RFID reader 100. The RF unit 110 may be coupled with the RFID tag 200 through a mutual induction that transfers power to the RFID tag 200. Under this condition, the RF unit 110 may transmit and receive data.

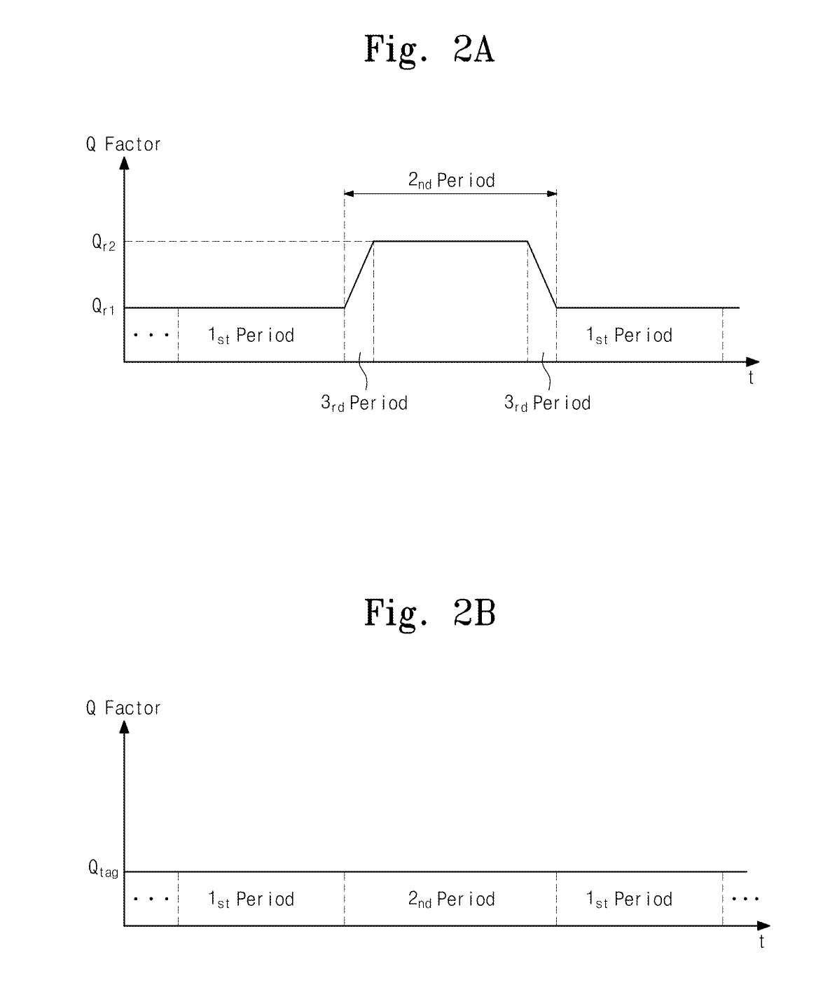

The RF unit 110 may perform data communication with the RFID tag 200 at an operating period (or mode) of the RFID reader 100.The operating period of the RFID reader 100 may include a first period (or mode), wherein the RF unit 110 communicates with the RFID tag 200, and a second period (or mode), wherein the RF unit 110 does not communicate with the RFID tag 200. For example, the first and second periods may be defined according to the ISO 14443 standard. The operating period of the RFID reader 100 will be more fully described with reference to FIG. 2A.

The RF unit 110 may be formed of an analog or digital circuit, for example. The RF unit 110 may have a quality factor (Q) which is determined according to characteristics and kinds of elements (e.g., a resistor, a capacitor, an inductor, etc.) included in a circuit of the RF unit 110. The quality factor (Q) may also be referred to as “selectivity” in this description. The quality factor of the RF unit 110 may be construed as having the same or similar characteristics as the quality factor of the RFID reader 100.

In the case that the quality factor of the RF unit 110 is high, power transfer efficiency into the RFID tag 200 may increase. Accordingly, power supplied to the RFID tag 200 from the RFID reader 100 may be sufficient to operate the RFID tag 200. In the case that the quality factor of the RF unit 110 is too low, power transfer efficiency into the RFID tag 200 may decrease. In this case, power supplied to the RFID tag 200 from the RFID reader 100 is not sufficient to operate the RFID tag 200.

The microcontroller unit 120 may control the quality factor of the RF unit 110 according to a variation in an operating period of the RFID reader 100. For example, when the operating period of the RFID reader 100 changes into a second period from a first period, the microcontroller unit 120 may control the RF unit 110 such that the quality factor of the RF unit 110 increases. On the other hand in the case that the operating period of the RFID reader 100 changes into the first period from the second period, the microcontroller unit 120 may control the RF unit 110 such that the quality factor of the RF unit 110 decreases. That is, the microcontroller unit 120 may control the quality factor of the RF unit such that the quality factor of the RF unit 110 at the second period (hereinafter, referred to as a second quality factor Qr2) is higher than the quality factor of the RF unit 110 at the first period (hereinafter, referred to as a first quality factor Qr1).

Further, the microcontroller unit 120 may control an overall operation of the RFID reader 100. For example, the microcontroller unit 120 may configure the operating periods of the RFID reader 100 according to the ISO 14443 standard. Also, the microcontroller unit 120 may function as a controller and/or processor to control an operation in which the RF unit 110 transmits and receives RF signals, for example.

The power supply 130 may supply an operating voltage to the RF unit 110 and the microcontroller 120.

As described above, a communications method having a relatively high data rate, such as VHBR, may use a wide bandwidth, while the quality factor of the RFID reader 100 is lowered. In such a case, the efficiency of power supplied to the RFID tag 200 may be lowered. However, according to at least one example embodiment, the microcontroller unit 120 of the RFID reader 100 may control the quality factor of the RF unit 110 according to a variation in an operating period.

In detail, under the control of the microcontroller unit 120, the first quality factor Qr1 of the RF unit 110 may be relatively low during the first period (i.e., when the RFID reader 100 and the RFID tag 200 perform data communication). In this case, it is possible to secure the wide bandwidth used by the VHBR communications method during the first period. Also, under the control of the microcontroller unit 120, the second quality factor Qr2 of the RF unit 110 may be set to be higher than the first quality factor Qr1 during the second period (i.e., when the RFID reader 100 and the RFID tag 200 do not perform data communication).Thus, the RFID reader 100 according to at least one example embodiment of the inventive concepts may improve communication efficiency during the first period and the power transfer efficiency during the second period. Accordingly, the communication performance between the RFID reader 100 and the RFID tag 200 may be improved.

FIG. 2A is a diagram illustrating an operating period of an RFID reader and a variation in a quality factor according to a variation in the operating period, as described with respect to at least one example embodiment. FIG. 2B is a diagram illustrating an operating period and a quality factor of a conventional RFID tag communicating with an RFID reader of FIG. 1.

Referring to FIG. 2A, an operating period of an RFID reader 100 may include a first period during which an RF unit 110 communicates with an RFID tag 200 and a second period during which the RF unit 110 does not communicate with the RFID tag 200. The first and second periods may be carried out according to the ISO 14443 standard. According to FIG. 2A, during the first period, both data communication and power transfer may be performed between the RFID reader 100 and the RFID tag 200. During the second period, only power transfer may be performed between the RFID reader 100 and the RFID tag 200.

As shown in FIG. 2A, the second period may include a third period during which a quality factor of the RF unit 110 decreases or increases. That is, the third period may be a period during which the quality factor is controlled according to a variation (or change) in an operating period of the RFID reader 100.

The RFID reader 100 may have a first quality factor Qr1 during the first period. For example, the first quality factor Qr1 may be a quality factor which satisfies a minimum magnetic field strength (e.g., 1.5 A/in), as defined by the ISO 14443 standard. The first quality factor Qr1 may be constant during the first period.

The RFID reader 100 may have a second quality factor Qr2 during the second period. For example, the second quality factor Qr2 may be higher than the first quality factor Qr1.

As illustrated in FIG. 2B, a quality factor Q_{tag} of the RFID tag 200 may be constant regardless of an operating period of the RFID tag 200. The operating period of the RFID tag 200 may be matched with an operating period of the RFID reader 100. That is, an operating period of the RFID tag 200 may include a first period where the RFID tag 200 communicates with the RFID reader 100 and a second period where the RFID tag 200 does not communicate with the RFID reader 100.

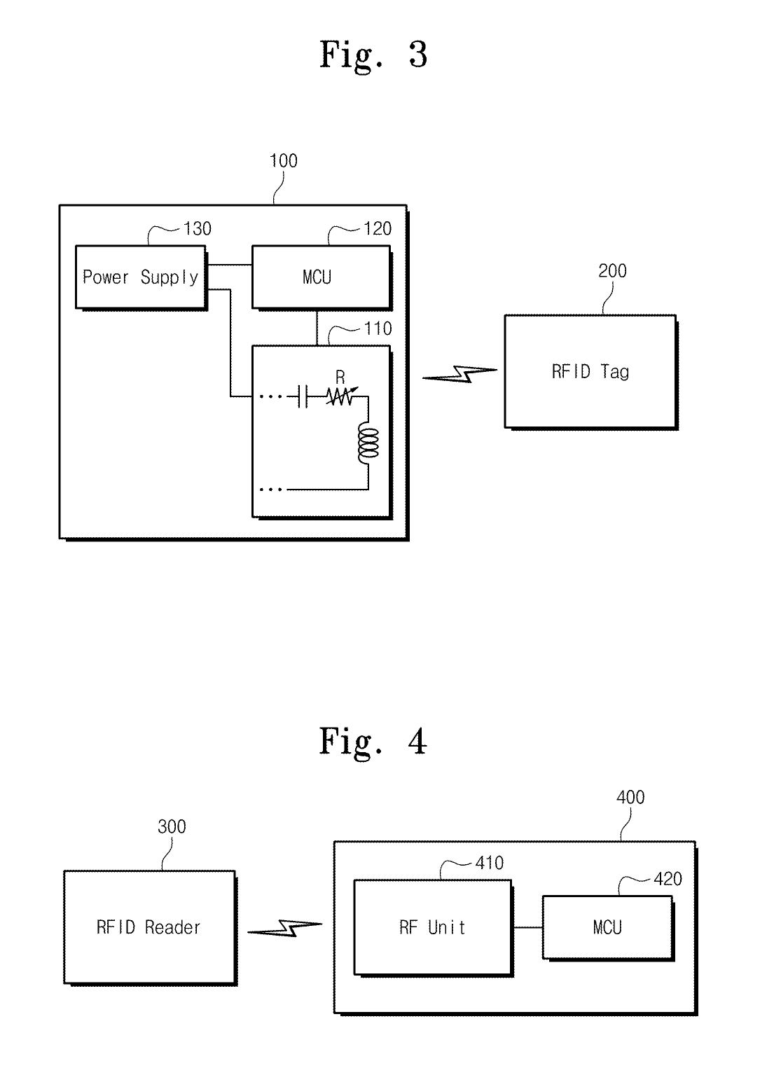

FIG. 3 is a block diagram schematically illustrating an equivalent circuit of an RF unit of an RFID reader of FIG. 1.

Referring to FIG. 3, an RF unit 110 of the RFID reader 100 may be configured to include an equivalent circuit formed of a variable resistor R, a capacitor C, and an inductor L. For example, the RF unit 110 of the RFID reader 100 may be configured to include an equivalent circuit in which the variable resistor R, the capacitor C, and the inductor L are connected in series. This equivalent circuit may be referred to an RLC serial resonance circuit. However, the inventive concepts are not limited thereto. For example, the RF unit 110 may be formed of an RLC parallel resonance circuit. An impedance of the RF unit 110 may be determined according to values of the elements R, L, and C of the resonance circuit.

According to at least one example embodiment, microcontroller unit 120 may decrease a resistance value of the variable resistor R when an operating period of the RF unit 110 is changed into a second period from a first period. According to at least one other example embodiment, the microcontroller unit 120 may increase a resistance value of the variable resistor R when the operating period of the RF unit 110 is changed into the first period from the second period. In the case that a resistance value of the variable resistor R decreases, a quality factor of the RF unit 110 may increase. In the case that a resistance value of the variable resistor R increases, a quality factor of the RF unit 110 may decrease. That is, the quality factor of the RF unit 110 may be controlled to have a first quality factor Qr1 during the first period and a second quality factor Qr2 higher than the first quality factor Qr1 during the second period.

Thus, a sufficient bandwidth may be secured for a communications method, such as VHBR. Further, communication efficiency may be improved during the first period and a power may be sufficiently supplied to the RFID tag 200 during the second period. Accordingly, overall communication performance between the RFID reader 100 and the RFID tag 200 is improved.

FIG. 4 is a block diagram schematically illustrating an RFID tag according to at least one example embodiment of the inventive concepts.

Referring to FIG. 4, an RFID tag 400 according to an example embodiment of the inventive concepts may include an RF unit 410 and a microcontroller unit 420. The RFID tag 400 may be a passive tag. That is, the RFID tag 400 may be supplied with a power from an RFID reader 300. The RFID tag 400 may further include a memory to store tag information and data.

When the RFID tag 400 approaches a coverage area of the RFID reader 300, the RF unit 410 may be electrically connected to the RFID reader 300. For example, the RF unit 410 may be coupled with the RFID reader 300 via a mutual induction and supplied with power from the RFID reader 300 so as to transmit and receive data.

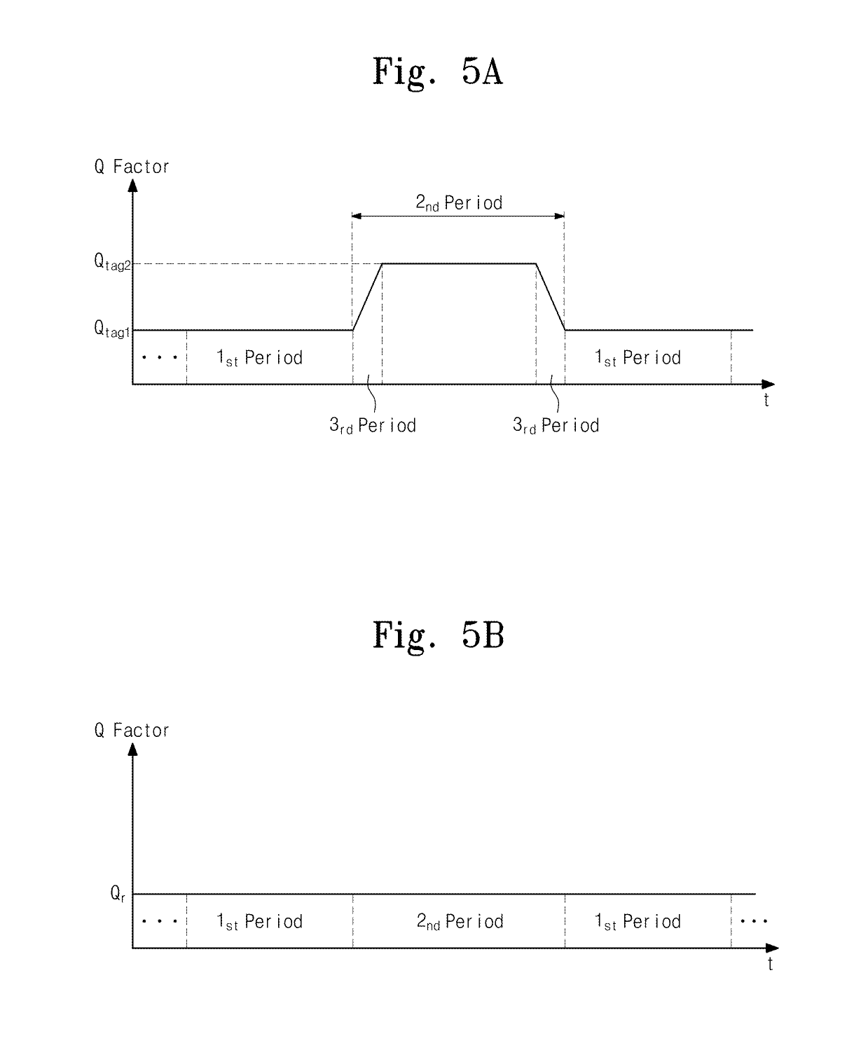

The RF unit 410 may perform data communication with the RFID reader 300 according to an operating period (or mode) of the RFID tag 400. The operating period of the RFID tag 400 may be the same as the operating period of the RFID reader 100 described with reference to FIG. 1. That is, the operating period of the RFID tag 400 may include a first period (or mode) during which the RFID tag 400 communicates with the RFID reader 300, and a second period (or mode) during which the RFID tag 400 does not communicate with the RFID reader 300.For example, the first and second periods may be operating periods defined by the ISO 14443 standard. The operating period of the RFID tag 400 will be more fully described with reference to FIG. 5A.

The RF unit 410 may be formed of an analog or digital circuit, for example. The RF unit 410 may have a quality factor which is determined according to characteristics and kinds of elements (e.g., a resistor, a capacitor, an inductor, etc.) within the RF unit 410. The quality factor of the RF unit 410 may correspond to a quality factor of the RFID tag 400.

In the case that the quality factor of the RF unit 410 is relatively high, power transfer efficiency from the RFID reader 300 may be relatively high. Accordingly, the RFID reader 300 may supply power to the RFID tag 400 that is sufficient to operate the RFID tag 400. In the case that the quality factor of the RF unit 410 is relatively low, power transfer efficiency from the RFID reader 300 may be relatively low. Accordingly, the RFID reader 300 does not supply sufficient power to operate the RFID tag 400.

The microcontroller unit 420 may control the quality factor of the RF unit according to a variation in an operating period of the RFID tag 400. For example, in the case that the operating period of the RFID tag 400 is changed into a second period from a first period, the microcontroller unit 420 may control the RF unit 410 such that the quality factor of the RF unit 410 increases. On the other hand, in the case that the operating period of the RFID tag 400 is changed into the first period from the second period, the microcontroller unit 420 may control the RF unit 410 such that the quality factor of the RF unit 410 decreases. That is, the microcontroller unit 420 may control the quality factor of the RF unit 410 such that the quality factor of the RF unit 410 at the second period (hereinafter, referred to as a second quality factor Q tag2) is higher than the quality factor of the RF unit 410 at the first period (hereinafter, referred to as a first quality factor Q tag1).

The microcontroller unit 420 may control an overall operation of the RFID tag 400. For example, the microcontroller unit 420 may configure the operating period of the RFID tag 400 according to the ISO 14443 standard. Also, the microcontroller unit 420 may store data received from the RFID reader 300 in a memory (not shown).

As described above, a communications method having a high data rate, such as VHBR, may use a wide bandwidth, while the quality factor of the RFID reader 300 is relatively low. In such a case, power supply efficiency from the RFID reader 300 may be relatively low. However, according to at least one example embodiment, the microcontroller unit 420 of the RFID tag 400 may control the quality factor of the RF unit 410 according to a variation in an operating period.

For example, under the control of the microcontroller unit 420, the first quality factor Q tag 1 of the RF unit 410 may be relatively low in the first period during which the RFID reader 300 and the RFID tag 400 perform data communication. In this case, it is possible to secure a sufficient bandwidth for VHBR communication. Also, under the control of the microcontroller unit 420, the second quality factor Q tag 2 of the RF unit 410 may be set to be higher than the first quality factor Q tag 1 in the second period during which the RFID reader 300 and the RFID tag 400 do not perform data communication. In this case, the RFID tag 400 may be sufficiently supplied with a power from the RFID reader 300. Thus, the RFID tag 400 according to at least one example embodiment of the inventive concepts may improve communication efficiency during the first period and power transfer efficiency during the second period. Accordingly, overall communication performance between the RFID reader 300 and the RFID tau 400 is improved.

FIG. 5A is a diagram illustrating an operating period of an RFID tag and a variation in a quality factor according to a variation in the operating period, according to at least one example embodiment. FIG. 5B is a diagram illustrating an operating period and a quality factor of a conventional RFID reader communicating with the RFID tag of FIG. 4.

Referring to FIG. 5A, an operating period of an RFID tag 400 may include a first period (or mode) during which the RFID tag 400 communicates with an RFID reader 300, and a second period (or mode) during which the RFID tag 400 does not communicate with the RFID reader 300. The first and second periods may be carried out according to the ISO 14443 standard. Durations of the first and second periods may be the same as that of the operating period of an RFID reader 100 described with reference to FIG. 2A. For example, during the first period, both data communication and power transfer may occur between the RFID reader 300 and the RFID tag 400. During the second period, only power transfer may occur between the RFID reader 300 and the RFID tag 400.

As shown in FIG. 5A, the second period may include a third period during which a quality factor decreases or increases. For example, the second period may include two third periods. That is, the third period may be a period where the quality factor is controlled according to a variation (or change) in an operating period of the RFID tag 400.

The RFID tag 400 may have a first quality factor Q tag 1 during the first period. For example, the first quality factor Q tag 1 may have a minimum value in order to generate power consumed when the RFID tag 400 performs data communication with the RFID reader 300 within a magnetic field (e.g., 1.5 A/m) of the RFID reader 300. The first quality factor Q tag 1 may be constant during the first period.

The RFID tag 400 may have a second quality factor Q tag 2 during the second period. The second quality factor Q tag 2 may be different from the first quality factor Q tag 1. For example, the second quality factor Q tag 2 may be higher than the first quality factor Q tag 1.

As illustrated in FIG. 5B, a quality factor Qᵣ of the RFID reader 300 may be constant regardless of an operating period. The operating period of the RFID tag 400 may be matched with an operating period of the RFID reader 300.

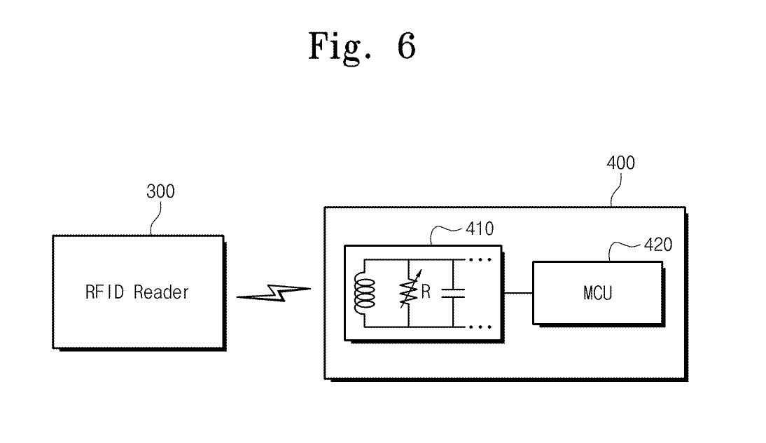

FIG. 6 is a block diagram schematically illustrating an equivalent circuit of an RF unit of an RFID tag of FIG. 4. In FIG. 6, the reference symbols may indicate the same elements as described with reference to FIG. 4.

Referring to FIG. 6, an RF unit 410 of the RFID tag 400 may be configured to include an equivalent circuit formed of a variable resistor R, a capacitor C, and an inductor L. For example, the RF unit 410 of the RFID tag 400 may be configured to include an equivalent circuit in which the variable resistor R, the capacitor C, and the inductor L are connected in parallel. This equivalent circuit may be referred to an RLC parallel resonance circuit. However, the inventive concepts are not limited thereto. For example, the RF unit 410 can be formed of an RLC serial resonance circuit. An impedance of the RF unit 410 may be determined by values of the elements R, L, and C of the resonance circuit.

With reference to FIGS. 5A and 6, the microcontroller unit 420 may be configured to decrease a resistance value of the variable resistor R when an operating period of the RF unit 410 is changed into the second period from the first period. The microcontroller unit 420 may be configured to increase a resistance value of the variable resistor R when the operating period of the RF unit 410 is changed into the first period from the second period. In the case that a resistance value of the variable resistor R decreases, a quality factor of the RF unit 410 may increase. In the case that a resistance value of the variable resistor R increases, a quality factor of the RF unit 410 may decrease. That is, the quality factor of the RF unit 410 may be controlled to have a first quality factor Q tag 1 during the first period and a second quality factor Q tag 2 higher than the first quality factor Q tag 1 during the second period.

Thus, a sufficient bandwidth may be secured for VHBR communication. Further, communication efficiency may be improved during the first period and a power may be sufficiently supplied to the RFID tag 400 from the RFID reader 300 during the second period. Accordingly, overall communication performance between the RFID reader 300 and the RFID tag 400 is improved.

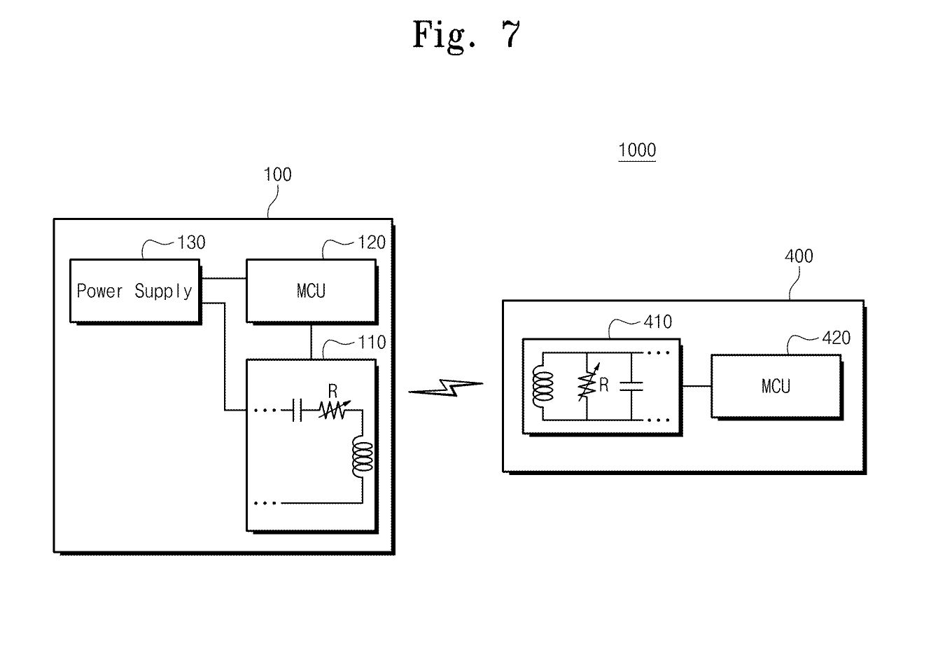

FIG. 7 is a block diagram schematically illustrating an RFID system according to at least one example embodiment of the inventive concepts.

Referring to FIG. 7, an RFID system 1000 according to at least one example embodiment of the inventive concepts may include an RFID reader 100 and an RFID tag 400. In at least one example embodiment, the RFID reader 100 may be an RFID reader 100 described with reference to FIGS. 1 to 3, and the RFID tag 400 may be an RFID tag 400 described with reference to FIGS. 4 to 6. In FIG. 7, reference numerals and symbols may indicate the same elements as described above with reference to FIGS. 1-6.

The RFID reader 100 may be electrically connected with a second RF unit 410 of the RFID tag 400.The RFID reader 100 may include a first RF unit 110 configured to perform data communication with the RFID tag 400 according to an operating period (or mode) of the RFID reader 100; a first microcontroller unit 120 configured to control a quality factor of the first RF unit 110 according to a variation (or change) in the operating period of the RFID reader 100; and a power supply 130 configured to supply a power to the first RF unit 110 and the first microprocessor 120.

The RFID tag 400 may be electrically connected with the RFID reader 100. The RFID tag 400 may include a second RF unit 410 configured to perform data communication with the RFID reader 100 according to an operating period (or mode) of the RFID tag 400; and a second microcontroller unit 420 configured to control a quality factor of the second RF unit 410 according to a variation (or change) in an operating period of the RFID tau 400.

Operating periods of the RFID reader 100 and the RFID tag 400 may coincide with each other. For example, each of the operating periods of the RFID reader 100 and the RFID tag 400 may include a first period (or mode) during which the RFID reader 100 and the RFID tag 400communicate with each other, and a second period (or mode) during which the RFID reader 100 and the RFID tag 400 do not communicate with each other. For example, the first and second periods may be carried out according to the ISO 14443 standard.

When the operating period of the RFID reader 100 is changed into the second period from the first period, the first microcontroller unit 120 of the RFID reader 100 may control the first RF unit 110 such that a quality factor of the first RF unit 110 increases. In this case, the operating period of the RFID tag 400 may be also changed into the second period from the first period. When the operating period of the RFID tag 400 is changed into the second period from the first period, the second microcontroller unit 420 of the RFID tag 400 may control the second RF unit 410 such that a quality factor of the second RF unit 410 increases. That is, as the operating period is changed into the second period from the first period, the quality factors of the RFID reader and tau 100 and 400 may increase at the same time.

When the operating period of the RFID reader 100 is changed into the first period from the second period, the first microcontroller unit 120 of the RFID reader 100 may control the first RF unit such that a quality factor of the first RF unit 110 decreases. In this case, the operating period of the RFID tag 400 may be also changed into the first period from the second period. When the operating period of the RFID tag 400 is changed into the first period from the second period, the second microcontroller unit 420 of the RFID tag 400 may control the second RF unit 410 such that a quality factor of the second RF unit 410 decreases. That is, as the operating period is changed into the first period from the second period, the quality factors of the RFID reader and tag 100 and 400 may decrease at the same time.

As described above, a communications method having a high data rate such as VHBR may use a wide bandwidth, while the quality factor of the RFID reader 100 is relatively low. Accordingly, power supply efficiency into the RFID tag 400 may be relatively low. However, the RFID reader 100 and the RFID tag 400 of the RFID system 1000 according to at least one example embodiment may control the quality factor according to a variation in an operating period.

For example, the quality factors of the RFID reader 100 and the RFID tag 400 may decrease at the first period where the RFID reader 100 and the RFID tag 400 perform data communication. In this case, it is possible to secure a bandwidth the communication manner such as VHBR requires. Also, the quality factors of the RFID reader 100 and the RFID tag 400 may be set to be higher than the quality factors of the first period at the second period where the RFID reader 100 and the RFID tag 400 do not perform data communication, so that a power is sufficiently supplied to the RFID tag 400. Thus, the RFID system 1000 according to an embodiment of the inventive concept may improve communication efficiency at the first period and the power transfer efficiency at the second period. That is, the RFID system 1000 may further improve the communication efficiency and the power transfer efficiency by controlling the quality factors of the RFID reader 100 and the RFID tag 400 at the same time.

While the inventive concept has been described with reference to exemplary embodiments, it will be apparent to those skilled in the art that various changes and modifications may be made without departing from the spirit and scope of the inventive concepts. Therefore, it should be understood that the above embodiments are not limiting, but illustrative.

What is claimed is:

1. An RFID reader for communication with an RFID tag, the RFID reader comprising:
an RF unit configured to communicate with the RFID tag according to an operating period of the RFID reader, the operating period including a first period in which the RF unit communicates with the RFID tag, the operating period including a second period in which the RF unit does not communicate with the RFID tag;
a microcontroller unit configured to control a quality factor of the RF unit according to a change in the operating period; and
a power supply configured to supply power to the RF unit and the microcontroller unit.

2. The RFID reader of claim 1, wherein the RF unit has a different quality factor associated with each of the first and second periods.

3. The RFID reader of claim 2, wherein the RF unit has a first quality factor in the first period and a second quality factor higher than the first quality factor in the second period

4. The RFID reader of claim 2, wherein the quality factor is constant in the first period.

5. The RFID reader of claim 2, wherein the second period includes a period during which the quality factor varies over time.

6. The RFID reader of claim 5, wherein the quality factor increases over time during a first duration of the period.

7. The RFID reader of claim 6, wherein the quality factor decreases over time during a second duration of the period.

8. The RFID reader of claim 1, wherein the microcontroller unit is configured to
control the RF unit such that the quality factor of the RF unit increases if the operating period changes to the second period from the first period, and
control the RF unit such that the quality factor of the RF unit decreases if the operating period changes to the first period from the second period.

9. The RFID reader of claim 1, wherein the RF unit includes a variable resistor, and the microcontroller unit is configured to control a resistance value of the variable resistor to determine an impedance of the RF unit.

10. The RFID reader of claim 9, wherein the variable resistor is connected in series with an inductor and a capacitor.

11. The RFID reader of claim 9, wherein the microcontroller unit is configured to
decrease a resistance value of the variable resistor if the operating period changes to the second period from the first period, and
increase a resistance value of the variable resistor if the operating period changes to the first period from the second period.

12. An RFID tag which communicates with an RFID reader, comprising:
an RF unit configured to communicate with the RFID reader according to an operating period of the RFID tag, the operating period including a first period during which the RF unit communicates with the RFID reader, the operating period including a second period during the RF unit does not communicate with the RFID reader; and
a microcontroller unit configured to control a quality factor of the RF unit according to a change in the operating period.

13. The RFID tag of claim 12, wherein the RF unit has a first quality factor in the first period and a second quality factor higher than the first quality factor in the second period.

14. The RFID tag of claim 12, wherein the microcontroller unit is configured to
control the RF unit such that the quality factor of the RF unit increases if the operating period is changed to the second period from the first period, and
control the RF unit such that the quality factor of the RF unit decreases if the operating period is changed to the first period from the second period.

15. The RFID tag of claim 12, wherein the RF unit includes a variable resistor connected in parallel with an inductor and a capacitor, and the microcontroller unit is configured to control a resistance value of the variable resistor to determine an impedance of the RF unit.

16. An RFID system, comprising:
an RFID reader; and
an RFID tag, each of the RFID reader and the RFID tag operating in a first period where the RFID reader and the RFID tag communicate with each other and a second period where the RFID reader and the RFID tag do not communicate with each other, and quality factors of the RFID reader and the RFID tag in the second period being higher than quality factors of the RFID reader and the RFID tag in the first period.

17. The RFID system of claim 16, wherein the RFID reader comprises:
a first RF unit configured to perform data communication with the RFID tag to correspond to an operating period of the RFID reader;
a first microcontroller unit configured to control a quality factor of the first RF unit according to a variation in the operating period; and
a power supply configured to supply a power to the first RF unit and the first microcontroller unit.

18. The RFID system of claim 17, wherein the RFID tag comprises:
a second RF unit configured to perform data communication with the RFID reader to correspond to an operating period of the RFID tag; and
a second microcontroller unit configured to control a quality factor of the second RF unit according to a variation in the operating period.

19. The RFID system of claim 18, wherein the quality factors of the RFID reader and the RFID tag are controlled at a same time.
